(19) United States
(12) Patent Application Publication
(10) Pub. No.: US 2019/0376212 A1
(43) Pub. Date: Dec. 12, 2019

(54) DOUBLE FABRIC FOR FIBER REINFORCED COMPOSITES

(71) Applicant: BGF Industries, Inc., Greensboro, NC (US)

(72) Inventors: Michael I. Bryant, Thomasville, NC (US); Blair Wayne Jenkins, Greensboro, NC (US); Benjamin Lincoln Whittier, II, Altavista, VA (US)

(73) Assignee: BGF Industries, Inc., Greensboro, NC (US)

(21) Appl. No.: 16/002,278

(22) Filed: Jun. 7, 2018

(51) Int. Cl. D03D 11/00; B32B 5/02; B32B 5/06; B32B 5/26

(52) U.S. Cl. CPC D03D 11/00; B32B 2250/20; B32B 5/06; B32B 5/26; D10B 2331/021; D10B 2401/04; D03D 2700/0111; D10B 2505/02; D03D 2700/0137; D10B 2101/06; D10B 2101/08; B32B 2250/02; B32B 2255/02; B32B 2262/0269; B32B 2262/101; B32B 2262/105; B32B 2307/3065; B32B 5/024

(57) ABSTRACT

A dual-layer fabric for reinforcing resin composite panels. The fabric includes a first layer and a second layer. Warp and weft yarns are interwoven with each other to form each of the first layer and the second layer. The warp yarns include both aramid yarns and high temperature organic yarns. The weft yarns include both aramid yarns and high temperature organic yarns.

### FIELD OF THE DISCLOSURE

The present disclosure relates to a fabric which is intended to be coated with a thermo-setting resin. The resulting composite having the fabric described herein can be suitable for creating strong, lightweight, fire-resistant wall panels or other components for use in cargo containers or other structures.

### BACKGROUND

Manufacturers increasingly are using fiber reinforced plastic (FRP) composite materials for a wide range of products, such as vehicles and sporting equipment. Composite panels also have been employed in the construction of air cargo containers. In many instances, the composite panels are created by laminating together a plurality of separate fiber reinforced resin sheets. In the past, the laminated construction allowed for variety in materials and performance among the separate sheets. For example, a laminated panel may include a first FRP sheet designed for its tensile strength characteristics, a second FRP sheet designed for its impact resistance, and a third FRP sheet designed for its fire-resistance. The use of separate sheets combined in laminated panels can increase the cost of production and the manufacturing cycle time.

Therefore, there is a need for improvements that may produce a FRP composite material that can include a reduced number of required sheets in a laminated panel and possibly provide within a single sheet the performance of a multi-sheet laminated construction.

### SUMMARY OF THE DISCLOSURE

One embodiment of the present disclosure includes a dual-layer fabric. Another embodiment of the present disclosure includes a fiber reinforced plastic composite having the dual-layer fabric as described. In one embodiment, dual-layer fabric includes a first layer and a second layer. Warp and weft yarns are interwoven with each other to form each of the first layer and the second layer. The warp yarns include both aramid yarns and high temperature organic yarns. The weft yarns include both aramid yarns and high temperature organic yarns.

These and other aspects of the present invention will become apparent to those skilled in the art after a reading of the following description of the preferred embodiments, when considered in conjunction with the drawings. It should be understood that both the foregoing general description and the following detailed description are explanatory only and are not restrictive of the invention as claimed.

### DESCRIPTION OF THE DRAWINGS

FIG. 1 is a photograph of the face of a double fabric according to an embodiment of the present disclosure.

FIG. 2 is a photograph of the back of the double fabric of FIG. 1.

FIG. 3 is a partial schematic perspective view of the face of the double fabric of FIG. 1.

FIG. 4 is a schematic end view of the double fabric of FIG. 3 taken from the direction D shown in FIG. 3.

FIG. 5 is the weave draft of the double fabric of FIGS. 1-4.

### DETAILED DESCRIPTION

Exemplary embodiments of this disclosure are described below and illustrated in the accompanying figures, in which like numerals refer to like parts throughout the several views. The embodiments described provide examples and should not be interpreted as limiting the scope of the invention. Other embodiments, and modifications and improvements of the described embodiments, will occur to those skilled in the art and all such other embodiments, modifications and improvements are within the scope of the present invention. Features from one embodiment or aspect may be combined with features from any other embodiment or aspect in any appropriate combination. For example, any individual or collective features of method aspects or embodiments may be applied to apparatus, product or component aspects or embodiments and vice versa.

The manufacture of fiber reinforced plastic (FRP) composites may involve obtaining a web of woven, non-woven, mat, unidirectional, or knit fibers. The fibers are then coated or impregnated with a resin through processes such as pultrusion or molding. The resin is then cured to form a structural sheet. In the past, a single-layer sheet often did not produce the desired performance, and several sheets would be laminated together. Lamination could occur by embedding a plurality of sheets in an encasing resin, or by adhering the layers together with adhesive or by other means before or after fully curing each sheet. The use of separate sheets followed by the laminating process is labor and material intensive, leading to relatively high manufacturing costs.

The inventors have sought to improve the process of manufacturing a FRP composite such that the finished product can reduce concerns about delamination between several layers, reduce material costs, and reduce labor costs by streamlining the manufacturing process. The inventors determined that these goals can be achieved if a single composite layer was able to provide similar strength and fire-resistance characteristics as a laminated multi-sheet construction. A single layer structure would have fewer manufacturing steps. The inventors further determined that a single-layer composite could replace existing multi-layer composites if the composite were reinforced with an improved fabric as described below. The improved fabric can be coated in a single step, eliminating steps from the manufacturing process. Fewer manufacturing steps can reduce costs.

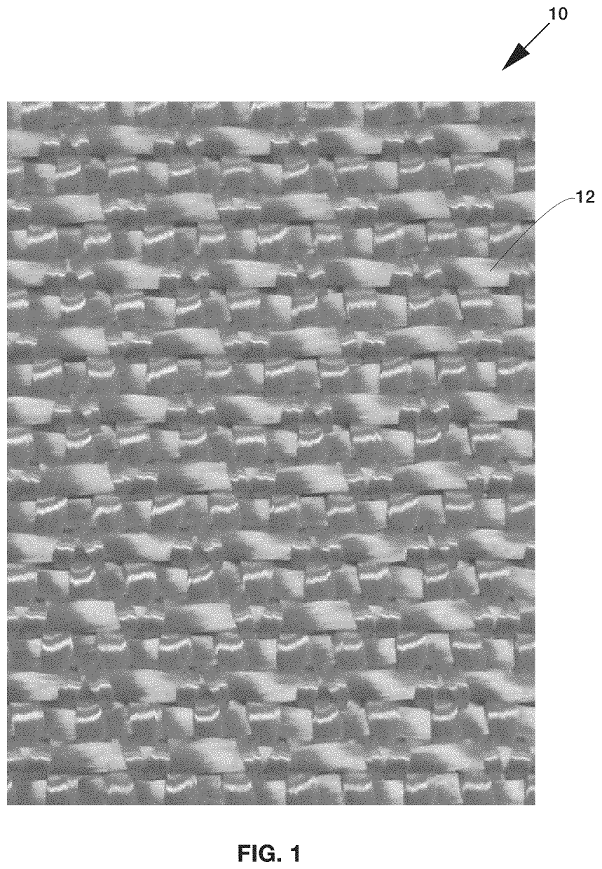

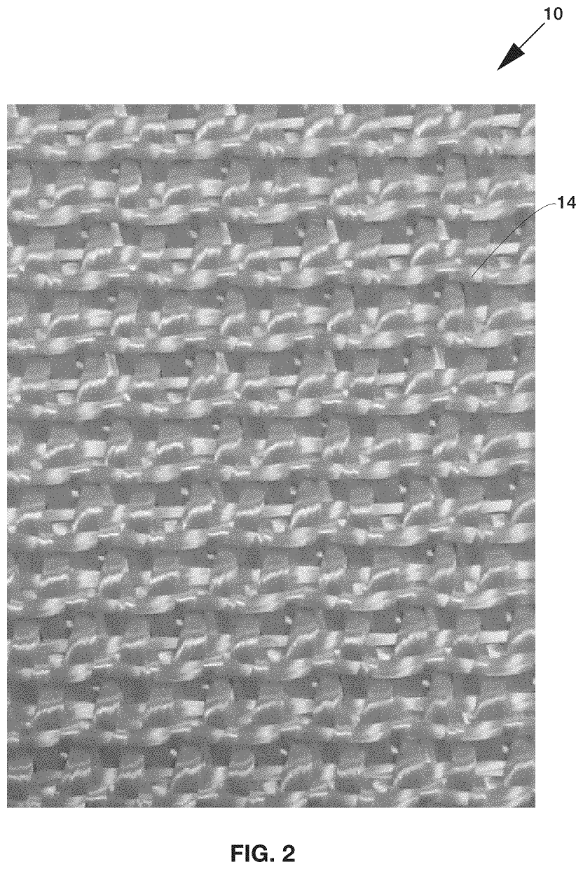

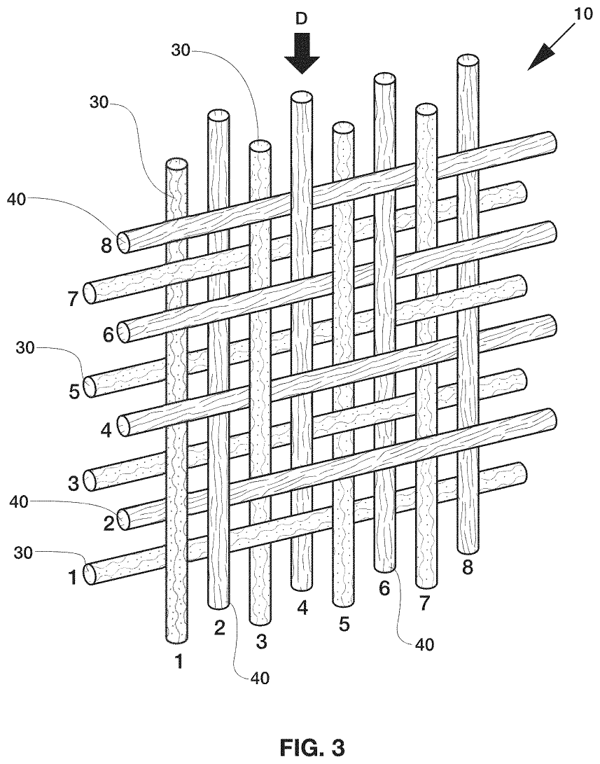

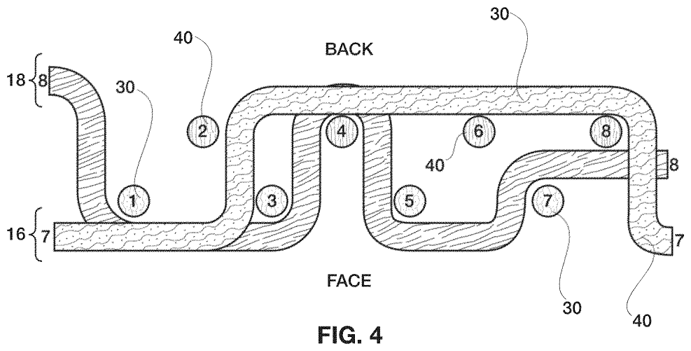

A fabric 10 for use in reinforcing resin or plastic composite materials according to the present disclosure is photographed in FIGS. 1 and 2. FIG. 1 shows the face 12 of the fabric 10, and FIG. 2 shows the back 14 of the fabric 10. FIG. 3 provides a schematic perspective view of the face 12 of the fabric 10, and FIG. 4 provides a schematic end view of the fabric 10. As possibly best shown in FIG. 4, the fabric 10 includes a first layer 16 and a second layer 18, such that the fabric 10 is a woven double fabric. As is known in the art, a double fabric is woven from separate sets of warp yarns and weft yarns to create a multi-layer or multi-ply fabric where the layers are combined and attached to one another during the weaving process. As is also well-known in the art, the term “warp” defines the longitudinal direction of the fabric and warp yarns extend along the longitudinal direction. A thread extending in the warp direction may also be called an “end.” The weft direction and likewise a weft yarn is the yarn drawn through traverse to the warp yarns. A thread in the weft direction may be referred to as a “pick.” The first layer 16 can present the face 12 of the fabric 10 and the second layer 18 can create the back 14 of the fabric.

As shown in FIG. 4, the first layer 16 may be woven primarily of face picks and face ends. The face picks and the face ends are designated with odd numbers (1, 3, 5, and 7) in FIGS. 3 and 4. The term “face” is used for clarity and consistency throughout this disclosure to refer to similarly positioned yarns, however one skilled in the art will appreciate that the first layer 16 may be woven as the technical back of the fabric instead. The second layer 18 may be woven primarily on back picks and back ends. The back picks and back ends are designated with even numbers (2, 4, 6, and 8) in FIGS. 3 and 4. Here also, the term “back” is used for clarity and consistency throughout the present disclosure, but the second layer 18 could be the technical face of the fabric 10.

In one example, the first layer 16 is woven in a 3/1 right hand twill where each face pick passes over one face end, and then under three face ends. A 3/1 twill pattern is often considered a warp dominant construction because it relates to the exposed surface of the first layer.

In one example, the second layer 18 is woven in a 1/3 left hand twill such that each back pick passes under one back end and over three back ends. A 1/3 twill pattern is often described as a weft dominant construction.

The first and second layers of the fabric are secured by using both raiser and sinker stitching. Raiser stitching occurs when back ends are raised over face picks. Sinker stitching occurs when face ends are lowered under back picks. This method of stitching is utilized to enable the first and second layers to be interlaced into a woven fabric of two layers. In one embodiment, particular stitch points are selected to provide balance to the weave design.

The fabric 10, photographed in FIGS. 1 and 2, schematically illustrated in FIGS. 3 and 4, and described in text above, may be created using a machine capable of weaving eight harnesses independently. The fabric 10 repeats every eight ends by every eight picks. The illustrated weave formed on an eight harness machine has been determined to hold fabric together at a preferred level of fabric density.

As mentioned above, the odd numbered ends (warp yarns), which correspond to the odd numbered harnesses 1, 3, 5, and 7 weave the first layer 16, and the even numbered ends (warp yarns), which also correspond with the even numbered harnesses 2, 4, 6, and 8, weave the second layer 18. Similarly, the odd numbered picks (weft yarns), which correspond to the odd numbered harnesses 1, 3, 5, and 7 weave the first layer 16, and the even numbered picks (weft yarns), which also correspond with the even numbered harnesses 2, 4, 6, and 8, weave the second layer 18.

In the illustrated example, a repeat of the weave pattern consists of eight picks and eight ends.

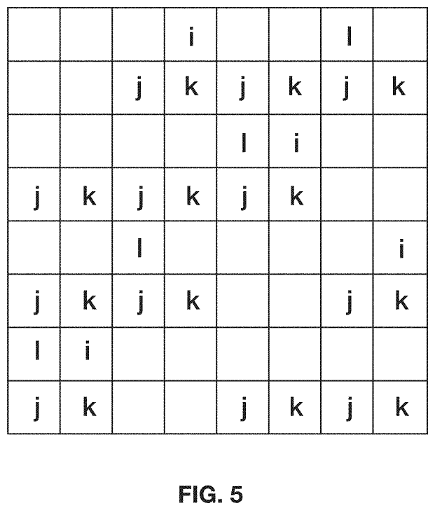

The fabric 10 photographed in FIGS. 1 and 2, schematically illustrated in FIGS. 3 and 4, and described in text above may be created according to the sample weave draft shown in FIG. 5. Cells of the weave draft with an “i” denote an intersection with a back pick passing under a back end. Cells of the weave draft with a “j” denote an intersection with a face pick passing under a face end. Cells of the weave draft with a “k” denote an intersection with a riser stitch and a face pick passing under a back end. Cells of the weave draft with an “1” denote the location of a sinker stitch where a back pick passes under the face end.

Also apparent to one of ordinary skill in the art from the weave draft of FIG. 5, on the first weft insertion, warp ends 1, 2, 5, 6, 7, and 8 weave identically (i.e. pass over the weft insertion). On the second weft insertion, warp ends 1 and 2 weave identically. On the third weft insertion, warp ends 1, 2, 3, 4, 7, and 8 weave identically. On the fourth weft insertion, warp ends 3 and 8 weave identically. On the fifth weft insertion, warp ends 1, 2, 3, 4, 5, and 6 weave identically. On the sixth weft insertion, warp ends 5 and 6 weave identically. On the seventh weft insertion, warp ends 3, 4, 5, 6, 7, and 8 weave identically. On the eight weft insertion, warp ends 4 and 7 weave identically.

The dual layer construction and weave pattern, such as the weave draft in FIG. 5, provide significant influence upon the performance of the fabric 10. In addition, the yarns selected for the face ends, back ends, face picks, and back picks may also contribute significantly to the performance and physical characteristics of the fabric 10 as described below.

In one embodiment, the fabric 10 is constructed from a combination of inorganic yarns, for example aramid yarns 30, and organic, high-temperature yarns 40, such as yarns made from e-glass (alumino-borosilicate), s-glass (alumino silicate glass with MgO and without CaO), quartz, silica, ceramic, basalt, or combinations thereof. Aramid is beneficial for high mechanical strength properties. Glass fibers or other organic, high-temperature yarns may support the fire resistance of the fabric 10.

In one embodiment, the organic high temperature yarns 40 are glass yarns, such as e-glass or s-glass. In one embodiment, the glass yarns are S-glass yarns of about 300 denier to about 600 denier. In one embodiment the organic high temperature yarns 40 may be multi-ply yarns, such as 2-ply or 3-ply. Therefore, the organic high temperature yarns 40 may have a total denier of about 1200 to about 1800.

In one embodiment, aramid yarns 30 may be used that are about 1500 to about 3000 denier. Again, each aramid yarn 30 may be plied for each pick or end such that a pick or end having aramid may have a total combined yarn denier of about 3000 to about 6000. In one embodiment, the aramid yarn 40 may be a twisted aramid yarn with between approximately one and approximately two twists per inch. The twist may be an S-twist or Z-twist.

In an example, the yarn count for the fabric 10 is between about thirty and about sixty-five warp yarns and between about thirty and about sixty-five weft yarns per inch total. Half the warp yarns will be face ends and half the warp yarns will be back ends. Similarly, half the weft yarns will be face picks and half the weft yarns will be back picks. One having ordinary skill in the art will appreciate that the yarn count can be related to the size of the yarns selected, with larger yarns requiring fewer yarns per inch to achieve similar performance.

In one embodiment, the organic high temperature yarn are the picks, and the aramid yarns provide the ends. In another embodiment, the picks are aramid and the ends are glass. In some embodiments, one or more of the yarns includes glass filaments and aramid filaments. In a preferred embodiment, the picks include both glass and aramid yarns and the ends include both glass and aramid yarns. In the fabric 10 of the photographed and illustrated embodiment, the ends alternate glass and aramid yarns, and the picks alternate glass and aramid yarns. Particularly, the face ends and face picks are aramid yarns 30 and the back ends and the back picks are organic high-temperature yarns 40, such as glass.

### Example

In one example, the fabric photographed in FIGS. 1 and 2 was woven from SCG 75 I/O glass yarns and 3220 dtex aramid yarns each alternating in both the weft and warp directions, with the glass yarns woven on the back picks and ends, and the aramid woven on the front picks and ends. Consistent with the discussion above, the first layer was a 3×1 right hand twill and the second layer was a 1×3 left hand twill with interweaving utilizing both raiser and sinker stitching according to the weave draft in FIG. 5.

The number of ends and picks were chosen to produce fabric with a weight from about 25 to about 26 ounces per square yard. The weight target was set for the particular illustrated example. Other fabrics may be heavier or lighter, such as in the wider range of about 20 to about 35 ounces per square yard. The sample fabric meeting the target weight had 48 ends per inch and 40 picks per inch. Again, because the aramid yarns and s-glass yarns were alternating on the picks and ends, half the ends and half the picks were each type yarn. The finished sample fabric weighed approximately 25.5 ounces per square yard.

The sample fabric was between about 65% and about 75% aramid, particularly 70% aramid, and between about 25% and about 35% high temperature organic yarns, particularly 30%, by weight. When tested according to ASTM D5035, the sample fabric demonstrated tensile strength in the warp direction of about 3000 lbs./inch and tensile strength in the fill direction of about 2700 lbs./inch.

The strength of the sample fabric is a result of the weave pattern and selected yarns, and may be specified in terms of the desired weight of the fabric. Therefore, one of ordinary skill in the art will appreciate that allowing for a heavier fabric can often produce even higher strength as the result of increasing the quantity of yarns and/or increasing the size of the yarns. The particular target weight, strength, and other performance characteristics may be impacted by the anticipated end use of the composite material that incorporates the fabrics of the present disclosure. The sample fabric 10 is believed to be particularly useful for composite panels in use environments such as air cargo containers.

As referenced above, the fabric described above may relate to one or more novel processes. For example, the manufacture of the fabric 10 may be described in terms of a method comprising obtaining aramid yarn and glass yarn. The method may also include preparing a weaving machine for weaving a dual-layer fabric where alternating harnesses in the warp direction are set with aramid yarn and glass yarn and alternating harnesses in the weft direction are set with aramid yarn and glass yarn. In one embodiment, the process comprises setting the machine to weave a first layer with the picks and ends having aramid and setting the machine to weave a second layer with picks and ends having glass. The process many further include programming the weaving machine according to the weave draft of FIG. 5.

In addition, the fabric 10 may be used in a process to create a fiber reinforced plastic. The method of forming the FRP may include obtaining a dual-layer fabric having aramid yarns and organic, high-temperature yarns. The method may further include impregnating the dual-layer fabric with a resin and curing the resin. The method any also include using the FRP without laminating it to another layer of composite material.

Although the above disclosure has been presented in the context of exemplary embodiments, it is to be understood that modifications and variations may be utilized without departing from the spirit and scope of the invention, as those skilled in the art will readily understand. Such modifications and variations are considered to be within the purview and scope of the appended claims and their equivalents.

1. A dual-layer fabric for reinforcing resin composite panels, the fabric comprising:
a first layer and a second layer;
respective warp and weft yarns are interwoven with each other to form each of the first layer and the second layer;
wherein the warp yarns include both aramid yarns and high temperature organic yarns, and
wherein the weft yarns include both aramid yarns and high temperature organic yarns.

2. The fabric of claim 1, wherein the first layer is woven in a 3×1 right hand twill weave.

3. The fabric of claim 1, wherein the second layer is woven in 1×3 left hand twill weave.

4. The fabric of claim 1, wherein the high temperature organic yarns are selected from the group comprising: e-glass, s-glass, quartz, silica, ceramic and basalt.

5. The fabric of claim 4 wherein the warp yarns alternate glass and aramid yarns.

6. The fabric of claim 5, wherein the weft yarns alternate glass and aramid yarns.

7. The fabric of claim 6, wherein the warp yarns comprising aramid and the weft yarns comprising aramid are woven on face ends and on face picks respectively.

8. The fabric of claim 6 wherein the glass yarns are between about 1200 and about 1800 total denier.

9. The fabric of claim 6, wherein the aramid yarns are between about 1500 and about 3000 total denier.

10. The fabric of claim 9, wherein the aramid yarn is a single ply yarn with 1.5 S-twists per inch.

11. The fibric of claim 1, wherein the warp and weft yarns are continuous filament yarns.

12. The fabric of claim 1 wherein fabric comprises a density within a range of about 30 to about 65 warp ends and weft ends per inch.

13. The fibric of claim 1, wherein the fabric has a tensile strength in the warp direction of between about 2600 and about 3600 lbs., and a tensile strength in the weft direction is between about 2000 and about 3000 lbs. as measured according to ASTM D 5035.

14. The fabric of claim 1, wherein the fabric comprises between about 65% and 75% aramid and between about 25% and about 35% high temperature organic yarns by weight.

15. The fabric of claim 1, wherein a weave pattern repeats every eight yarns in both the warp and the weft direction.

16. The fabric of claim 1, comprising a weave pattern according to the weave draft of FIG. 5, wherein:
an “i” denotes an intersection with a back pick passing under a back end;
a “j” denotes an intersection with a face pick passing under a face end;
a “k” denotes an intersection with a riser stitch and a face pick passing under a back end; and
an “l” denotes the location of a sinker stitch where a back pick passes under the face end.

17. A fiber reinforced resin composite, comprising:
the fabric of claim 1; and
a resin coating covering the fabric.

18. A dual-layer fabric for reinforcing resin composite panels, the fabric comprising:
a first layer and a second layer,
respective warp and weft yarns are interwoven with each other to form each of the first layer and the second layer;
wherein the warp yarns include both aramid yarns and high temperature organic yarns,
wherein the weft yarns include both aramid yarns and high temperature organic yarns,
wherein the high temperature organic yarns are selected from the group comprising: e-glass, s-glass, quartz, silica, ceramic and basalt,
wherein the warp yarns alternate glass and aramid yarns,
wherein the weft yarns alternate glass and aramid yarns, and
wherein the warp yarns comprising aramid and the weft yarns comprising aramid are woven on face ends and on face picks respectively.
